(19) United States
(12) Patent Application Publication
(10) Pub. No.: US 2016/0102175 A1
(43) Pub. Date: Apr. 14, 2016

(54) RING-OPENING LAUROLACTAM POLYMERIZATION WITH LATENT INITIATORS

(71) Applicant: Yvonne BURGER, Datteln (DE)

(72) Inventors: Friedrich Georg SCHMIDT, Haltern am See (DE); Sandra REEMERS, Muenster (DE); Klaus BERGER (Deceased), (US); Matthias ULLRICH, Essen (DE); Michael BUCHMEISER, Remshalden (DE); Stefan NAUMANN, Heilbronn (DE)

(73) Assignee: EVONIK DEGUSSA GMBH, Essen (DE)

(21) Appl. No.: 14/891,827

(22) PCT Filed: May 26, 2014
(86) PCT No.: PCT/EP2014/060753

§ 371 Date: Nov. 17, 2015

(30) Foreign Application Priority Data
Jun. 5, 2013 (DE) 10 2013 210 424.3

(51) Int. Cl. C08G 69/00; B29C 39/00; B29C 45/00; C08G 63/08; C08L 77/02

(52) U.S. Cl. CPC C08G 69/00; C08G 63/08; C08L 77/02; B29C 45/0001; B29C 39/006; B29K 2077/10

(57) ABSTRACT

The present invention relates to a rapid and innovative mechanism for initiating anionic ring-opening polymerization of laurolactam by means of latent initiators on the basis of thermally activatable N-heterocyclic carbene compounds, such as, more particularly, N-heterocyclic carbene-CO₂ compounds and carbene-metal compounds (NHCs). With the new initiation mechanism it is possible accordingly to realize molecular weights (M_{w}) of from 2000 up to more than 30,000 g/mol, and narrow polydispersities. The polymerizations may be carried out both in bulk and in solution in a suitable solvent. Compounds of this type are thermally latent and on heating initiate a polymerization to polylaurolactam in high yields, up to a quantitative conversion, whereas at room temperature there is no reaction. Polydispersity and molecular weight of the polylaurolactam can be adjusted through the choice of the initiator and of the reaction conditions.

### FIELD OF THE INVENTION

The present invention relates to a rapid and innovative mechanism for initiating anionic ring-opening polymerization of laurolactam by means of latent initiators on the basis of thermally activatable N-heterocyclic carbene compounds, such as, more particularly, N-heterocyclic carbene-CO₂ compounds and carbene-metal compounds (NHCs). With the new initiation mechanism it is possible accordingly to realize molecular weights (M_{w}) of from 2000 up to more than 30,000 g/mol, and narrow polydispersities. The polymerizations may be carried out both in bulk and in solution in a suitable solvent. Compounds of this type are thermally latent and on heating initiate a polymerization to polylaurolactam in high yields, up to a quantitative conversion, whereas at room temperature there is no reaction. Polydispersity and molecular weight of the polylaurolactam can be adjusted through the choice of the initiator and of the reaction conditions.

### PRIOR ART

Lactams are generally polymerized by means of an anionic ring-opening polymerization. Initiators used for this polymerization are bases, or Lewis bases. Suitable accordingly are, for example, metal alkyls, amines, phosphines or alkoxides. More particularly, alcoholates are used for the anionic ring-opening polymerization (ROP) of lactams.

Alternatively a cationic ring-opening polymerization is also suitable. This polymerization can be initiated with protic acids, Lewis acids or else alkylating agents. Overall, however, the cationic polymerization shows a tendency towards secondary reactions, such as transesterifications or cyclizations, for example. The attainable molecular weight is therefore reduced significantly in relation to an anionic ROP.

A feature common to these methods, however, is that the polymerization begins even at low temperatures, such as room temperature. This makes laurolactam only very poorly suited, according to the prior art, for particular applications, such as especially for the production of composite materials. For this application, a temperature-dependent latency of the initiator or initiator system would be required.

N-Heterocyclic carbenes (NHCs) have already long been known as initiators for the silyl initiators in a group transfer polymerization (GTP) (cf. Raynaud et al., Angew. Chem. Int. Ed., 2008, 47, p. 5390, and Scholten et al., Macromolecules, 2008, 41, p. 7399). N-Heterocyclic carbenes are also known as initiators in a step-growth polymerization of terephthalaldehyde (cf. Pionaud et al., Macromolecules, 2009, 42, p. 4932). Zhang et al. (Angew. Chem. Int. Ed., 2010, 49, p. 10158) disclose NHC also as a Lewis base in combination with Lewis acids, such as NHC.Al(C₆F₅)₃ or NHC—BF₃, for example. This combination is a suitable initiator for MMA. Zhang et al. (Angew. Chem., 2012, 124, p. 2515) disclose 1,3-di-tert-butylimidazolin-2-ylidene on its own as well as an initiator for the polymerization of MMA or of furfuryl methacrylate. In those contexts, however, it has been found that other NHCs have no initiating effect for MMA, but instead only for the cyclic monomers such as α-methylene-γ-butyrolactone (MBL) or γ-methyl-α-methylene-γ-butyrolactone (MMBL). Moreover, the carbenes employed here have a very high inherent reactivity, which means first that the operation is difficult and second that the polymerization is initiated quickly and in a way which is relatively difficult to control.

Kamber et al. (Macromolecules 2009, 42, pp. 1634-1639) describe substituted imidazoles as N-heterocyclic carbenes (NHCs) for the initiation of a ROP of ε-caprolactone. This polymerization takes place with high activity even at room temperature. Nyce et al. (J. Am. Chem. Soc., 2003, 125, pp. 3046-3056) describe for this purpose the formation of carbene in situ from an imidazole halide with an alcoholate. Here as well the polymerization takes place spontaneously at room temperature with a very high rate. Shion et al. (Macromolecules, 2011, 44, pp. 2773-2779) describe the same method, with imidazole-ylidenes. These zwitterions lead—again at room temperature—to polymers having significantly higher molecular weights.

The German patent application with the file reference 102013205186.7 describes the polymerization of lactones, such as ε-caprolactone, for example, by initiation with protected N-heterocyclic carbenes.

### Object

An object of the present invention, against the background of the prior art discussed, was to provide new latent initiators for the polymerization of laurolactam. This polymerization ought to be able to be initiated in a controlled way and at the same time, following initiation, ought to be able to be carried out quickly and easily.

A further object of the present invention was to provide a latent initiator compound which is stable for at least 8 hours in the presence of monomers at temperatures of up to 40° C., leading therefore at most to a 5% monomer conversion, and which at the same time, following activation, leads to an at least 90% conversion of the monomers to polymers.

Furthermore, the compounds used as latent initiators are to be inherently stable on storage and are to be easy and safe to handle.

Furthermore, a mixture of the initiators and laurolactam is to be stable on storage such that a woven or knitted structure can be impregnated with the mixture without problems and thereafter a composite material can be produced from the impregnated woven or knitted structures by activation of the polymerization.

Another object, furthermore, is to prepare copolymers of laurolactam and other lactams and/or lactones by means of a suitable initiation mechanism.

Other objects, not explicitly stated, may become apparent from the description, the examples and the claims, despite having not been explicitly recited at this point.

### Achievement

The objects are achieved by means of an innovative method for initiating a polymerization of laurolactam. In this method, the monomers or the monomer solution are or is admixed with a protected N-heterocyclic carbene and the polymerization is commenced by the raising of the temperature to an onset temperature which is at least 60° C., preferably at least 80° C. In the case of a bulk polymerization, the onset temperature is above the melting temperature of the monomer mixture. This melting temperature is easily determined by the skilled person. Pure laurolactam has a melting temperature of around 150° C. The polymerization in bulk is commenced with particular preference at a temperature between 150° C. and 220° C. A particular feature of the initiators of the invention is that they exhibit little or no activity at a relatively low temperature, more particularly at room temperature, and therefore that a mixture of the initiators and the laurolactam is stable on storage. “Little activity” in this context means that in a mixture of the laurolactam and the initiator there is not more than a 5% conversion of the monomers over a period of 20 hours at room temperature.

Suitable more particularly are protected N-heterocyclic carbenes having a pKa of at least 24, preferably between 24 and 30. Protected N-heterocyclic carbenes with a lower basicity have little or no initiator activity. This pKa is based on the value at 25° C. in anhydrous DMSO.

Such mixtures therefore lend themselves especially well to the production of composites. For this purpose, for example, supports in fibre form, in the form for example of preshaped scrims or knitted structures, are impregnated with the mixture and then heated to the initiation temperature. The precise initiation temperature here is dependent on the particular initiator, i.e. on the carbene and on the protecting group used, and can easily be determined in each individual case by a skilled person.

In the case of a solution polymerization, the choice of the solvent must be made by the skilled person on the basis of a variety of factors. Thus the solvent must have good dissolution properties for the monomers, for the initiators, and optionally for the resultant polymer, at the polymerization temperature. The solvent ought also not to be too protic, in order to prevent parallel initiation. Furthermore, it is self-evident that the solvent must be suitable for the particular operating parameters, such as temperature and pressure. One example of a suitable solvent is DMSO.

In the case of the production of composite materials, the supports in fibre form may consist, for example, of glass, carbon, plastics, such as polyamide (aramid) or polyesters, or of natural fibres or mineral fibre materials such as basalt fibres or ceramic fibres. These fibres preferably form a sheetlike textile made of nonwoven, knitted fabrics, including loop-drawn knits or formed-loop knits, non-knitted structures such as woven fabrics, laid scrims or braided fabrics. The fibres may alternatively take the form simply of long-fibre or short-fibre material.

This method is suitable for the polymerization of laurolactam. Additionally, mixtures of laurolactam and other lactams and/or lactones may be polymerized with the method of the invention.

The protected N-heterocyclic carbene comprises more particularly a compound having one of the two formulae (I) or (II):

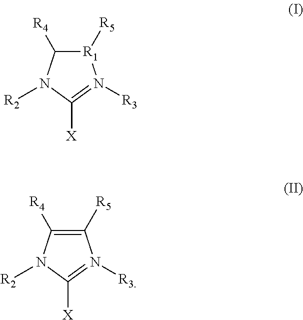

R₁ here is a CH₂, C₂H₄, C₃H₆ or a corresponding substituted radical. R₂ and R₃, may be identical or in each case different relative to one another. Preferably R₂ and R₃ are each a cyclic, branched or linear alkyl radical having 1 to 20 carbon atoms and optionally containing heteroatoms, or are a substituted or unsubstituted aromatic radical. R₄ and R₅ may be identical or in each case different relative to one another. Preferably R₄ and R₅ are each hydrogen, a cyclic, branched or linear alkyl radical having 1 to 20 carbon atoms and optionally containing heteroatoms, or a substituted or unsubstituted aromatic radical. X is CO₂, CS₂, Zn, Bi, Sn or Mg, with the metals recited standing as representatives of different metal compounds. More particularly the metallic protecting groups are ZnX′₂, BiX′₃, SnX′₂ or MgX′₂, where X′ is a halogen or a pseudohalogen, preferably Cl. The metallic protecting groups may also have further, coordinated molecules, such as a solvent molecule, more particularly tetrahydrofuran (thf).

Carbenes having one of these groups X are stable on storage and are both easy and safe to use. Preferred are carboxylates (CO₂ protecting group) or dithionates (CS₂ protecting group), since with these compounds the polymerization can take place in metal-free form.

Examples of the N-heterocyclic parent structure of the initiators used in accordance with the invention are more particularly imidazole, imidazoline, tetrahydropyrimidine and diazepine.

Alternatively the protected N-heterocyclic carbene may be a compound having one of the two formulae (III) or (IV)

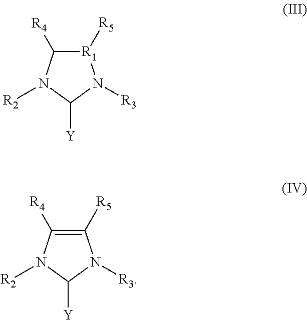

Particularly in the case of compounds of the formulae (II) and (III) with R₁═CHR₅, the pKa values lie within the limiting range of the inventively useful carbenes. In these cases the basicity of the compounds is dependent on the substituents R₂ to R₅, more particularly on R₂ and R₃. Whether a compound is suitable is therefore something which must be ascertained beforehand by a determination of the pKa at 25° C. in anhydrous DMSO.

Here, again, R₁ is a CH₂, C₂H₄, C₃H₆ or a corresponding substituted radical. R₂ and R₃ may likewise again be identical or in each case different relative to one another. In these cases as well this radical is preferably a cyclic, branched or linear alkyl radical having 1 to 20 carbon atoms and optionally containing heteroatoms, or a substituted or unsubstituted aromatic radical. R₄ and R₅ may be identical or in each case different relative to one another. Preferably R₄ and R₅ are each hydrogen, a cyclic, branched or linear alkyl radical having 1 to 20 carbon atoms and optionally containing heteroatoms, or a substituted or unsubstituted aromatic radical. The protecting group Y, in contrast, may be a CF₃, C₆F₄, C₆F₅, CCl₃ or OR₄ radical, with R₄ as an alkyl radical having 1 to 10 carbon atoms. In analogy to the compounds (I) and (II), the compounds (III) and (IV) may also be N-heterocyclic carbenes having a metallic protecting group comprising Zn, Bi, Sn or Mg. Here again, the metals recited stand as representatives of various metal compounds. More particularly the metallic protecting groups are ZnX′₂, BiX′₃, SnX′₂ or MgX′₂, with X′ being halogen or pseudohalogen, preferably Cl. Furthermore, the metallic protecting groups may have further, coordinated molecules, such as a solvent molecule, more particularly tetrahydrofuran (thf), for example.

Shown below are a number of CO₂-protected N-heterocyclic carbenes, with no intention that this listing should be interpreted as being restrictive in any form at all. In particular, even the protecting group here may be replaced by one of the other protecting groups recited. Examples of N-heterocyclic carbenes of the formula (I) with a six-membered ring—that is, R₁ is a (CH₂)₂ group—are 1,3-dimethyltetrahydropyrimidinium-2-carboxylate (1), 1,3-diisopropyltetrahydropyrimidinium-2-carboxylate (2), 1,3-bis(2,4,6-trimethylphenyl)tetrahydropyrimidinium-2-carboxylate (3),1,3-bis(2,6-diisopropylphenyl)tetrahydropyrimidinium-2-carboxylate (4), 1,3-biscyclohexyltetrahydropyrimidinium-2-carboxylate (12), 1,3-bis(4-heptyl)tetrahydropyrimidinium-2-carboxylate (13) and 1,3-bis(2,4-dimethoxyphenyl)tetrahydropyrimidinium-2-carboxylate (15):

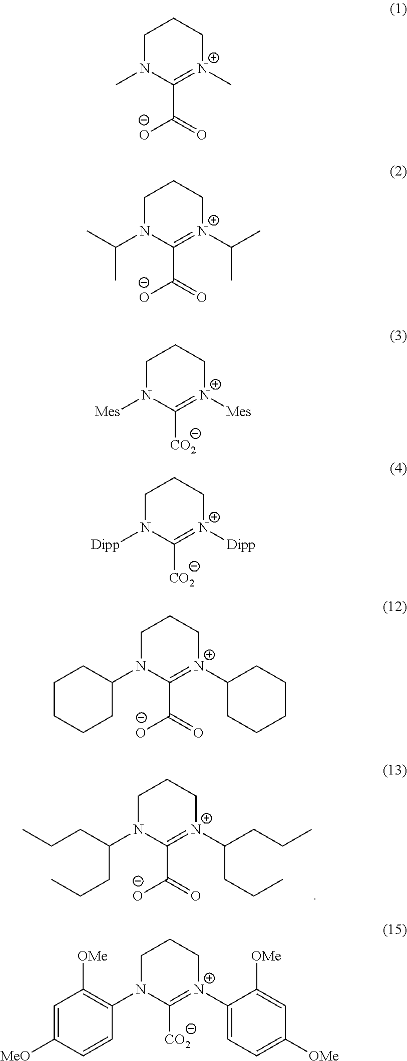

Here, Mes stands for a 2,4,6-trimethylphenyl group, and Dipp for a 2,6-diisopropylphenyl group.

The polymerization with six-membered, protected, N-heterocyclic carbenes as initiators constitutes a preferred embodiment of the present invention, on account of the high basicity of these carbenes. These carbenes are more preferably six-membered N-heterocycles of the formula (I) with R₁═C₂H₄. Accordingly R₅ in formula (I) is a hydrogen atom.

Examples of formula (I) with a seven-membered ring, i.e. where R₁ is a (CH₂)₃ group, are 1,3-bis(2,4,6-trimethylphenyl)tetrahydro[1,3]diazepinium-2-carboxylate (10) and 1,3-bis(2,6-diisopropylphenyl)tetrahydro[1,3]diazepinium-2-carboxylate (11):

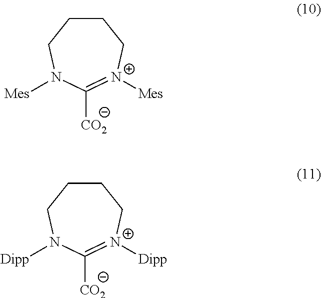

Examples of compounds of formula (II) are 1,3-diisopropylimidazolium-2-carboxylate (5), 1,3-di-tert-butylimidazolium-2-carboxylate (6), 1,3-dicyclohexylimidazolium-2-carboxylate (7), 1,3-bis(2,4,6-trimethylphenyl)imidazolium-2-carboxylate (8) and 1,3-adamantylimidazolium-2-carboxylate (9):

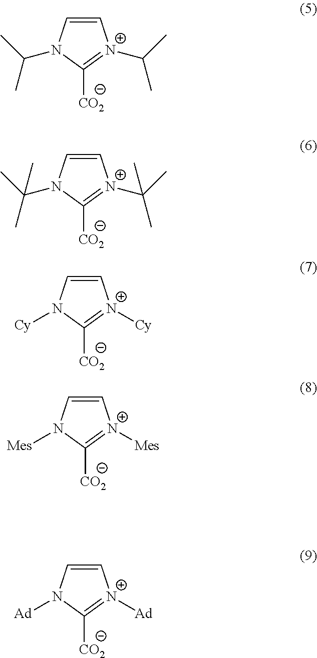

Here, Cy stands for a cyclohexyl group, and Ad for an adamantly group. In the case of the doubly unsaturated, protected, five-membered-ring N-heterocyclic carbenes, the basicity is very dependent on the respective substituents. While compound (6) initiates a polymerization with high conversion at 180° C., compound (5) is unsuitable under the same conditions.

Examples of initiators of the formula (I) with R₁ as CH₂ are 1,3-di-tert-butylimidazolinium-2-carboxylate (14) and 1,3-di(2,4,6-trimethylphenyl)imidazolinium-2-carboxylate (14a):

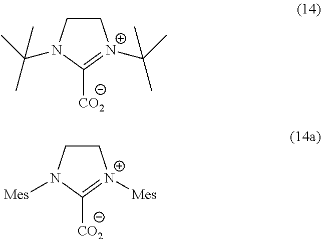

The singly unsaturated five-membered rings of the compounds (14) and (14a) have a sufficient basicity and are suitable as initiators for laurolactam polymerization.

Examples of metal-protected N-heterocyclic carbenes are the compounds (16) to (19):

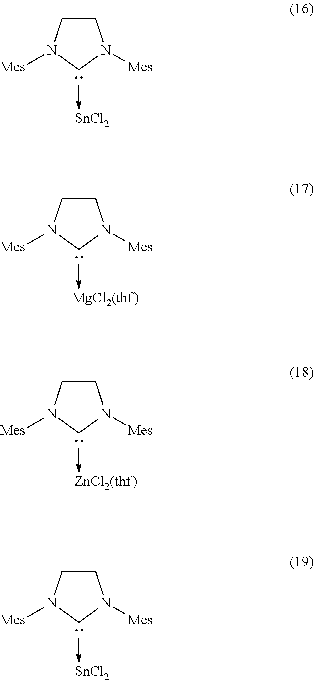

Here it is found that the less basic five-membered N-heterocyclic carbenes even in the case of a metal protecting group do not lead to polymerization at 180° C., on account of the low basicity. In contrast, the compound (19) is entirely suitable as an initiator.

The metal-protected N-heterocyclic carbenes may also be present in a dimeric form. One example of this is the compound (20):

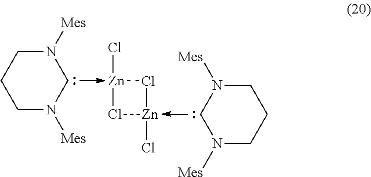

The preparation of these compounds is general knowledge from the literature. The cyclization of amidines, which are readily available from amines and orthoesters, allows easy access to different ring sizes, in particular.

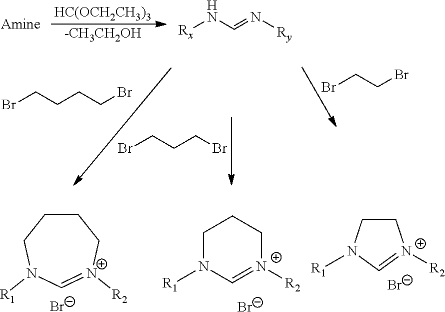

This is preferably followed by deprotonation with a strong, sterically hindered base, such as potassium hexamethyldisilizane (KHMDS), for example, in a solvent such as THF, for example. The solvent is removed and the residue is slurried with Et₂O, for example. Following filtration, CO₂ or another protecting group such as SnCl₂, for example, is added. A further, subsequent filtration in diethyl ether, for example, and drying under reduced pressure allow the synthesis of clean target compounds, and so often there is no longer any need even for recrystallization. Together with the simple formation of amidines and their cyclization with dihalides, an attractive synthesis pathway with a minimal number of steps is available, with which there is no need for any chromatography or other purifying operations. These two reactions may also be carried out under an air atmosphere, for example. Only the formation of the free carbene by reaction with a strong base has to be carried out in the absence of air. The synthesis may be found in, for example, Iglesias et al., Organometallics 2008, 27, 3279-3289. The synthesis of corresponding CS₂ complexes can be found in, for example, Delaude, Eur. J. Inorg. Chem. 2009, 1681-1699 or Delaude et al., Eur. J. Inorg. Chem. 2009, 1882-1891.

Surprisingly it has been found that the polymerization can take place very rapidly at relatively low temperatures of 180° C., for example, depending on the selection of the protected N-heterocyclic carbene. For instance, at 180° C., an 80% conversion of the monomers is possible even at t₅₀<50 min. At the same time, the polymerization solutions, or else a pure monomer mixture containing the N-heterocyclic carbene, can be combined in such a way that they do not lead to any polymerization for a number of hours at room temperature. A great advantage of the present invention is therefore the latency of the polymerization.

This relationship affords great advantages in industrial processes. Accordingly, reaction mixtures can be prepared and can be initiated in a controlled way at any desired point in time through a simple raising of the temperature. Hence the mixtures, for example, can be mixed outside a reaction vessel and transferred into a reaction vessel only for the actual polymerization. Furthermore, on the basis of an initiator system of this kind, a continuous polymerization may take place with continuous addition of the reaction mixture to a tubular or loop reactor or to an extruder or kneading apparatus.

The polymerization may also be optimized such that conversion of the monomers is almost quantitative. This is possible both in solution polymerization and in bulk polymerization.

With the method of the invention, furthermore, the molecular weights of the polymers can be set within a broad spectrum. Thus it is possible more particularly to produce polymers having a weight-average molecular weight, as determined by a GPC measurement against a polystyrene standard of between 5000 and 50,000 g/mol.

A field of application of the initiation method of the invention that is an alternative to the production of composite materials is the use of the method for producing cast polyamides.

Cast polyamides are usually polyamides of particularly high molecular weight. They are produced by purely chemical means, and generally without pressurization. In one form, the monomeric base materials, including laurolactam, are polymerized to the polyamide with heating. For this purpose, mixtures of the monomer composition—i.e. laurolactam and optional comonomers—and the latent initiators of the invention are poured or injected into a mould. After the polymerization has been initiated in the mould by raising of the temperature to the onset temperature, a homogeneous material is produced which has particularly high crystallinity, and which again significantly exceeds the extruded polyamides in terms of the outstanding properties. Characteristics of semi-finished products and mouldings made from cast polyamides are, in particular, the combination of toughness with great hardness, the high abrasion resistance, the effective damping capacity, and the continued ready processability of these materials. This is especially true of a cast polyamide 12 manufactured from laurolactam. Typical applications for this material are large machine elements, e.g. sliding bearings, drive elements, pulleys for cable vehicles, heavy-load rollers for gantry cranes, or stamping plates.

The advantage of the method of the invention in the context of producing such cast polyamides is the high level of control over the operation. With the method of the invention it is possible to fill out a mould with the monomer composition, including the initiator component, completely, not until before the polymerization is deliberately initiated. This leads to greater dimensional accuracy and surface quality on the part of the end product, and, during the casting operation, to a much simpler and more reliable procedure, since there is no need for initiation prior to casting, such initiation being mandatory according to the prior art.

Accordingly, the composite materials producible by means of the method described earlier on above, and also the castings producible by this method, are also part of the present invention.

### EXAMPLES

### General Polymerization Procedure

For the polymerization, laurolactam, the initiator, optionally benzyl alcohol and optionally a solvent, such as DMSO, DMF or toluene, for example, were weighed out together and transferred to a glove box under an argon atmosphere. The laurolactam was used in technical grade (98% purity) without particular purification. In the case of a solution polymerization, dried DMSO was used as solvent and a Schlenk flask was used as the reaction vessel. After the end of the reaction time, reaction was terminated by addition of m-cresol and the product was dissolved in m-cresol at a temperature of 190° C. The product was subsequently precipitated from an acetone solution which had been cooled beforehand, and was isolated by filtration and washed three times with acetone. The yield was determined by weighing the product after drying under a high vacuum.

The precise amounts and the nature of the initiators and any further components used can be seen from Table 1.

Table 1 contains initial results of a bulk polymerization of laurolactam (monomer).

TABLE 1

| | | | | Molar | | |
|---|---|---|---|---|---|---|
| | | | | ratio | | |
| | | Temperature | Time | NHC/ | Yield | M_{w} (PDI) |
| Example | NHC | [° C.] | [h] | monomer | [%] | [g/mol] |
| 1 | (2) | 180 | 45 | 1:100 | 82 | 24 300 (2.9) |
| 2 | (12) | 180 | 45 | 1:100 | 100 | 18 900 (2.6) |
| 3 | (12) | 180 | 45 | 1:200 | 100 | n.d. |
| 4 | (13) | 180 | 45 | 1:100 | 93 | 15 400 (2.3) |
| 5 | (6) | 180 | 45 | 1:100 | 71 | 21 000 (2.8) |
| 6 | (14) | 180 | 45 | 1:100 | 96 | 18 300 (2.6) |
| CE1 | — | 180 | 45 | — | — | — |
| CE2 | (13) | 20 | 45 | 1:100 | — | — |
| CE3 | (5) | 180 | 45 | 1:100 | — | — |
| CE4 | (18) | 180 | 45 | 1:100 | — | — |

The conversion, the onset temperature and the molecular weight can be set through the choice of initiators and the polymerization temperature. It is also apparent that even quantitative conversions are achievable within very short polymerization times.

Table 1 also includes comparative examples (CE). CE1 shows that the same system without addition of the inventive initiator does not exhibit polymerization activity. CE2 shows that in accordance with the invention there is no polymerization, or no significant polymerization, at room temperature. The systems are therefore latent.

CE3 and CE4 show that protected N-heterocyclic carbenes with a low basicity, i.e. with a pKa of less than 24, do not initiate polymerization at 180° C.

1. A method for initiating a polymerization of laurolactam comprising:
admixing a laurolactam-comprising monomer solution or mixture with a protected N-heterocyclic carbene, which has a pKa of at least 24 as determined in anhydrous DMSO,
commencing polymerization by the raising of the temperature to an onset temperature, which is at least 60° C. and in the case of a bulk polymerization is above the melting temperature of the monomer mixture.

2. The method as claimed in claim 1, wherein the protected N-heterocyclic carbene is a compound having one of the two formulae (I) or (II): 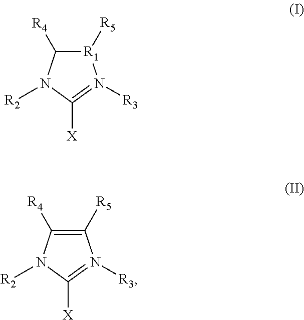
where
R₁ is a CH₂, C₂H₄, C₃H₆ or a corresponding substituted radical, R₂ and R₃, identically or in each case differently with respect to one another, are a cyclic, branched or linear alkyl radical having 1 to 20 carbon atoms and optionally containing heteroatoms, or are a substituted or unsubstituted aromatic radical, R₄ and R₅, identically or in each case differently relative to one another, are hydrogen, a cyclic, branched or linear alkyl radical having 1 to 20 carbon atoms and optionally containing heteroatoms, or are a substituted or unsubstituted aromatic radical, and X is CO₂, ZnX′₂, BiX′₃, SnX′₂ or MgX′₂, where X′ is a halogen or a pseudohalogen.

3. The method as claimed in claim 1, wherein the protected N-heterocyclic carbene is a compound having one of the two formulae (III) or (IV): 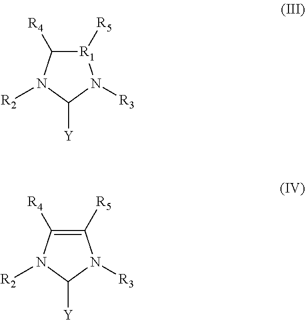
where
R₁ is a CH₂, C₂H₄, C₃H₆ or a corresponding substituted radical, R₂ and R₃, identically or in each case differently with respect to one another, are a cyclic, branched or linear alkyl radical having 1 to 20 carbon atoms and optionally containing heteroatoms, or are a substituted or unsubstituted aromatic radical, R₄ and R₅, identically or in each case differently relative to one another, are hydrogen, a cyclic, branched or linear alkyl radical having 1 to 20 carbon atoms and optionally containing heteroatoms, or are a substituted or unsubstituted aromatic radical, and Y is a CF₃, C₆F₄, C₆F₅, CCl₃, or OR₄ radical, with R₄ as an alkyl radical having 1 to 10 carbon atoms, ZnX′₂, BiX′₃, SnX′₂ or MgX′₂, where X′ is a halogen or a pseudohalogen.

4. The method as claimed in claim 1,
wherein the polymer obtained from the method has a weight-average molecular weight, in a GPC measurement against a polystyrene standard, of between 5000 and 50,000 g/mol.

5. The method claim 1, wherein the polymerization is a bulk polymerization and wherein the onset temperature is between 150° C. and 220° C.

6. The method of claim 1, wherein the protected N-heterocyclic carbenes have a pKa of between 25 and 30.

7. The method of claim 1 wherein the protected N-heterocyclic carbenes are six-membered N-heterocycles of the formula (I) with R₁═C₂H₄.

8. The method as claimed in claim 1, wherein the monomer mixture or monomer solution comprises not only laurolactam but also ε-caprolactone and/or one or more lactones.

9. The method as claimed in claim 1, wherein prior to the polymerization a carrier material in fibre form is impregnated with a composition comprising laurolactam, optional comonomers and protected N-heterocyclic carbenes and then the temperature is raised to the onset temperature.

10. The method as claimed in claim 1, wherein a composition comprising laurolactam, optional comonomers and protected N-heterocyclic carbenes is poured or injected into a mould and the polymerization is initiated in this mould by an increase in temperature to the onset temperature.

11. A composite material produced by the method of claim 9.

12. A moulding produced by the method of claim 10.
